(19) United States
(12) Patent Application Publication
(10) Pub. No.: US 2006/0239526 A1
(43) Pub. Date: Oct. 26, 2006

(54) Method and apparatus for acquiring and processing images of an article such as a tooth

(75) Inventors: Gediminas Jonusauskas, Talence (FR); Jean Oberle, Bordeaux (FR); Emmanuel Abraham, Leognan (FR)

Correspondence Address: BIRCH STEWART KOLASCH & BIRCH, PO BOX 747, FALLS CHURCH, VA, 22040-0747, US

(73) Assignees: CENTRE NATIONAL DE LA RECHERCHE SCIENTIFIQUE, Paris (FR); UNIVERSITE DE BORDEAUX 1, Talence Cedex (FR)

(21) Appl. No.: 11/304,630

(22) Filed: Dec. 16, 2005

Related U.S. Application Data
(63) Continuation of application No. PCT/FR04/01411, filed on Jun. 7, 2004.

(30) Foreign Application Priority Data
Jun. 17, 2003 (FR) 03 07294

(51) Int. Cl. A61C 19/00; G06K 9/00; H04N 7/18

(52) U.S. Cl. 382/128; 382/162; 433/25; 348/66

(57) ABSTRACT

A method of acquiring and processing images of an article, such as a tooth in the mouth, for example, the apparatus comprising an ultraviolet light source for illuminating the article, a matrix-type video camera for taking video images of the article illuminated in ambient light and in ultraviolet light, and control and data processor means.

The invention relates to a method and apparatus for acquiring and processing images of an article, such as a tooth in the mouth, that is illuminated in ultraviolet light.

### BACKGROUND OF THE INVENTION

Document WO-A-02/096281 discloses a method of detecting dental caries early, which method consists in illuminating a tooth in the mouth with ultraviolet light having a wavelength in the range approximately 300 nanometers (nm) to approximately 370 nm, in order to excite the emission of fluorescence by the mineral portion of the tooth, in taking video images of the tooth in two wavelength bands in the emission spectrum, respectively a high-energy band and a low-energy band, in measuring the spectral intensity of the fluorescence emitted in those two bands at each point of the image of the tooth, in taking the ratio of the intensities measured in the two bands at each point of the image, and in comparing the ratios with a predetermined value.

The ratio of the intensities measured in a wavelength and lying between the excitation wavelength and about 600 nm, and in a wavelength band lying in between about 550 nm and 800 nm, is indicative of the presence of caries when it is less than a predetermined value that depends on the sensitivities of the photodetectors of the video means used for taking images in said two wavelength bands.

The apparatus used for performing that method comprises a laser and filters for illuminating the tooth by successive pulses of ultraviolet light and visible light, and the means for taking the image comprise a spectral filter device having two filters, one of which transmits signals in the high-energy wavelength band and the other signals in the low-energy wavelength band, and a video camera which receives in succession the signals transmitted in the high-energy band, the signals transmitted in the low-energy band, and signals corresponding to the image of the tooth when illuminated in visible light. Data processor means calculate the above-specified ratio at each point of the image of the tooth on the basis of the output signal from the camera and display on a screen an image of tooth fluorescence and a visible light image of the tooth, thus enabling any caries that might be present in the image of the tooth to be located accurately.

That known apparatus operates in satisfactory manner, but it is relatively expensive. It is also relatively slow, since it is necessary to interpose filters in succession in front of the camera in order to acquire the images of tooth fluorescence in the two wavelength bands and also the image of the tooth in visible light.

### OBJECTS AND SUMMARY OF THE INVENTION

A particular object of the present invention is to mitigate those drawbacks.

The invention provides a method and apparatus of the above-specified type which are applicable in particular to early detection of dental caries, and more generally to detecting spoilage and variations in the properties of optically-accessible surfaces and volumes of any kind of article whatsoever, the method and the apparatus using equipment and components that are simple and inexpensive.

The invention also provides a method and apparatus of the above-specified type that enable images of the article under examination to be acquired and processed more quickly and more accurately.

To this end, the invention provides a method of acquiring and processing images of an article, such as a tooth in the mouth, for example, the method consisting in illuminating the article in ultraviolet light, in using video means to take images of the illuminated portion of the article, in measuring at each point of said images the spectral intensity of the luminescence emitted by the article in two wavelength bands respectively at high energy and at low energy, in taking the ratio of said measurements at each point of the image of the article, and in comparing said ratios with a predetermined value, the method consisting:
in taking at least one color video image of said portion of the article illuminated in ambient light;
in taking at least one color video image of the luminescence produced by said portion of the article in response to being illuminated in ultraviolet light;
in subtracting the ambient light video image from the luminescence video image at each point of the luminescence image in order to obtain a pure image;
in extracting the spectral components of the pure image in said high-energy and low-energy wavelength bands; and
in taking the ratios of said components at each point of the image and in comparing said ratios with a predetermined value.

Thus, in the method of the invention, it suffices to illuminate the article in ambient light and to illuminate the article in ultraviolet light in order to be able to use a color video camera to obtain the information needed for calculating the above-specified ratios, and there is no longer any need to use filters that are switched in front of the video camera, since use can be made directly of the components of the video images in the high-energy and low-energy wavelength bands.

Advantageously, the method of the invention consists in using a video camera of the red-green-blue type for taking the images of the article, and in extracting the red and blue components from the video images in order to calculate the above-specified ratios.

The invention also provides apparatus for performing the method, the apparatus comprising an ultraviolet light source for illuminating an article, video means for taking an image of the illuminated portion of the article, and data processor means receiving the output signals from the video means, wherein the video means comprise a color video camera, and wherein the data processor means are designed to subtract, point by point, an image of the portion of the article illuminated in ambient light from an image of the portion of the article illuminated in ultraviolet light so as to obtain a pure image, to extract the components from said pure image in the two wavelength bands respectively at high energy and at low energy, to take the ratios point by point of these two components, and to compare them with a predetermined value.

Advantageously, the color video camera used is a charge-coupled device (CCD) matrix camera of the “webcam” type having a cost price that is relatively very low (typically less than 100 euros).

According to other characteristics of the invention, the apparatus includes display means for displaying a result made up of the image points for which the ratios are less than (or respectively greater than) the predetermined value.

The ultraviolet light source used in the apparatus is preferably a light-emitting diode (LED) emitting ultraviolet light in a narrow band of wavelengths centered on appropriately 370 nm, for example.

Apparatus comprising these means has a cost price that is very low, but is nevertheless of surprising reliability and accuracy.

In a preferred embodiment of the invention, both the ultraviolet light source and the color video camera including an image-forming objective lens are received in a housing of small dimensions and they are connected by a flexible cable to the data processor means.

The housing can be handled like an endoscope and makes it easy to take images of teeth in the mouth.

Where necessary, it may also include a visible light source for illuminating the article, when ambient lighting is not sufficient or when the sensitivity of the photodetectors of the camera is rather low.

In general terms, the invention is applicable to detecting spoilage and variation in the properties of optically-accessible surfaces, interfaces, and volumes of any kind of article whatsoever in a variety of fields such as oncology, biology, geology, ecology, industrial inspection, etc.

### BRIEF DESCRIPTION OF THE DRAWINGS

The invention can be better understood and other characteristics, details, and advantages thereof can appear more clearly on reading the following description given by way of example and made with reference to the accompanying drawings, in which:

FIG. 1 is a diagrammatic view of the apparatus of the invention;

FIG. 2 is a flow chart of the main steps in the method of the invention;

FIG. 3 is a diagram showing an image of fluorescence of a tooth in the mouth; and

FIG. 4 is a graph showing the variations in the luminescence ratios in the high-energy and low-energy spectral bands along two lines in the image of FIG. 3.

### MORE DETAILED DESCRIPTION

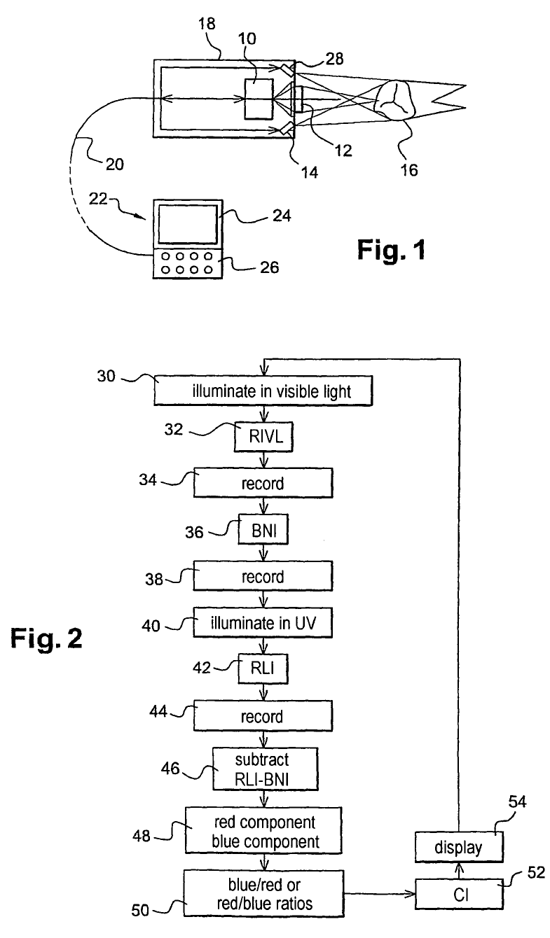

As shown diagrammatically in FIG. 1, the apparatus of the invention essentially comprises means for taking a color video image constituted by a matrix 10 of photodetectors such as photodiodes or CCD photodetectors, and an objective lens 12 for forming an image on the matrix 10 of photodetectors, together with a source 14 of ultraviolet light for illuminating an article 16 situated in front of the lens 12, such as a tooth in the mouth, for example.

In a preferred embodiment of the invention, the matrix 10 of photodetectors and the lens 12 are parts of a “webcam” type color video camera, e.g. comprising a matrix of 320 pixels×240 pixels and having a size of ¼ of an inch (4 millimeters (mm) in diagonal), and a lens with a focal length of 5 mm, as is available on the market at a price that is relatively very low.

The source of ultraviolet light is advantageously a light-emitting diode (LED) emitting in a narrow band of wavelengths centered on about 370 nm.

The camera 10, 12 and the source 14 of ultraviolet light are mounted inside a housing 18, e.g. of cylindrical shape, that is of small dimensions, e.g. of the endoscope type and easily handled in one hand, or in a variant mounted steerably on a hinged suspension or support arm.

A flexible cable 20 connects the components 10, 14 housed in the housing 18 to a control unit 22 comprising data processor means, a display screen 24, and a control keypad 26, together with means for electrically powering the apparatus of the invention.

A light source 28 of any suitable type may also be housed in the housing 18 to illuminate the article 16 in visible light, preferably in white light.

The apparatus is used as follows:

The housing 18 is placed properly relative to the article 16 so as to enable said article to be illuminated in ultraviolet light and possibly also in visible light, and so as to form a sharp image of the article on the matrix 10 of photodetectors in the camera.

The first step of the method of the invention comprises, where necessary, illuminating 30 the article 16 in visible light by means of the source 28, taking 32 a color or gray-scale video image of the article 16, said image being a reference image in visible light RIVL, recording 34 said image in a memory of the unit 22, and switching off the visible light source 28.

The following step of the method comprises taking 36 a color image of the article 16 illuminated in ambient light, in order to obtain a background noise image BNI, and recording 38 said image in the memory of the unit 22.

The following step of the method comprises illuminating 40 the article 16 in ultraviolet light by means of the source 14, taking 40 a color video image of the article 12, said image being a raw luminescence image RLI, recording 44 said image in the memory of the unit 22, and switching off the ultraviolet light source 14.

The illumination of the article 16 in ultraviolet light is implemented in the form of pulses of a duration corresponding to the exposure time of the CCD camera, each pulse causing the mineral portion of the tooth to fluoresce, and the illumination pulses being separated from one another by a time interval that is adapted to sequences of acquiring empty frames.

To improve accuracy and reduce noise, it is possible to accumulate a plurality of video frames corresponding to reference images in visible light RIVL, background noise images BNI, and raw luminance images RLI, and then averaging them, the number of frames accumulated being the same for each type of image.

The following steps of the method comprise:
at 46, point-by-point (pixel by pixel or pixel group by pixel group) subtraction of the ambient light image BNI from the raw luminescence image RLI in order to obtain a pure luminescence image LI;
at 48, extracting the red and blue components LIr and LIb from the pure luminescence image LI;
at 50, calculating the ratio LIb/LIr (or LIr/LIb) point by point;
at 52, comparing these ratios with a predetermined value; and
at 54, displaying a caries image CI constituted by those points for which the above-mentioned ratio LIb/LIr is less than a predetermined value (or the points for which the ratio LIr/LIb is greater than a predetermined value).

Advantageously, the screen 24 displays the caries image CI in false color simultaneously with the image of the tooth as illuminated in visible light or in ambient light. This makes it easy to identify accurately which zones of the tooth under examination present caries.

Thereafter, the control unit restarts an acquisition and measurement cycle from the beginning, i.e. from step 30.

Illuminating the article under examination in visible light is of advantage only if the video image of the article in ambient light is not good enough.

In most circumstances, the sensitivity of the video camera photodetectors enable illumination of the article in visible light by means of the source 28 to be omitted.

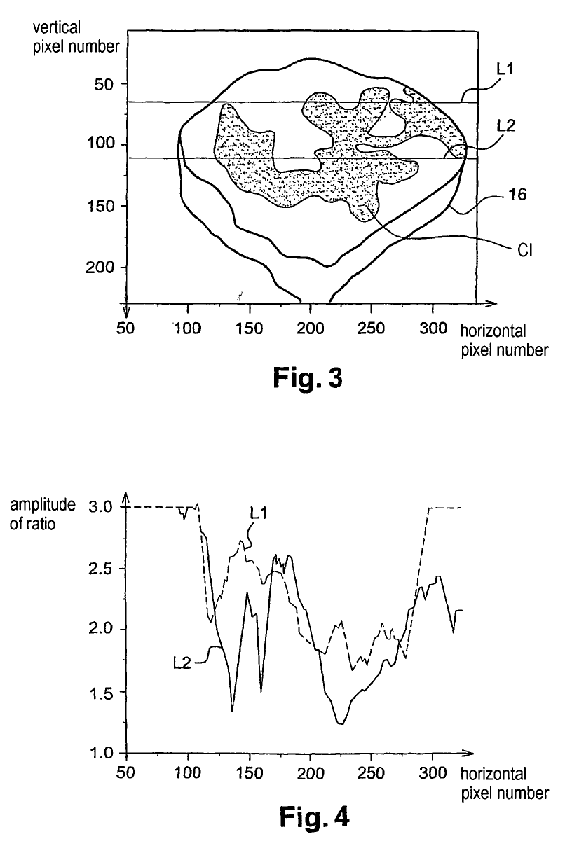

FIG. 3 is a diagram of a caries image CI which is displayed in false colors, e.g. in red or in blue, possibly superimposed on an image of a tooth illuminated in visible light RIVL or in ambient light BNI, with the abscissa giving the horizontal row pixel numbers in the matrix of camera photodetectors, and with the ordinates giving the vertical column pixel numbers of the photodetectors of said matrix.

FIG. 4 applies to two measurement lines L1 and L2 in the image of FIG. 3, showing variations in the ratio LIb/LIr as a function of pixel number along the above-mentioned horizontal rows.

Values of this ratio that are close to 2.5 correspond to healthy enamel, while values that are less than 2 correspond to caries.

A certain number of variants may be applied to the apparatus of the invention as described and shown, without going beyond the ambit of the invention as described in the following claims.

For example, the video sensor 10 of the apparatus of the invention could be a CCD type matrix sensor or a photodiode matrix sensor, or a CMOS type matrix sensor, or indeed a color vidicon, or any other matrix device for acquiring a color image or a color video sequence.

The means for forming the image on the video sensor may be constituted by one or more objective lenses, mirrors, optical fiber image guides, etc. . . . , and in general any means that enable an image of an article 16 to be formed on the video sensor 10.

The source 14 for illumination in ultraviolet light may be an LED as mentioned above, some other semiconductor component, a thermal source, an electric discharge lamp, a laser, etc. . . . , that produces ultraviolet light in the wavelength band approximately 300 nm to 370 nm, serving to excite luminescence in the mineral portion of the tooth 16.

The light emitted by this source is not required to comply with any criterion concerning monochromaticity, coherence, or polarization state. Naturally, the light source may be associated with optical means for collimating, transmitting, and/or attenuating the power of the emitted light beam.

Similarly, the visible light source 28 may be an LED, some other semiconductor component, a thermal source, an electric discharge lamp, a laser, etc. . . . , and in general any means enabling visible light to be generated, and preferably write light for illuminating the article 16.

The light source 28 may be associated with means for collimating, transmitting, and/or attenuating the power of the emitted light beam.

The light sources 14 and 28 may be point sources or extended sources, they may be single or multiple, and they may be assembled on the housing 18 at one end thereof or they may be remote from the end, with the light being conveyed by optical fibers, for example.

What is claimed is:

1. A method of acquiring and processing images of an article, such as a tooth in the mouth, the method consisting in illuminating the article in ultraviolet light, in using video means to take images of the illuminated portion of the article, in measuring at each point of said images the spectral intensity of the luminescence emitted by the article in two wavelength bands respectively at high energy and at low energy, in taking the ratio of said measurements at each point of the image of the article, and in comparing said ratios with a predetermined value, the method consisting:
in taking at least one color video image of said portion of the article illuminated in ambient light;
in taking at least one color video image of the luminescence produced by said portion of the article in response to being illuminated in ultraviolet light;
in subtracting the ambient light video image from the luminescence video image at each point of the luminescence image in order to obtain a pure image;
in extracting the spectral components of the pure image in said high-energy and low-energy wavelength bands; and
in taking the ratios of said components at each point of the image and in comparing said ratios with a predetermined value.

2. A method according to claim 1, consisting in displaying on a screen a result made up of image points for which the above-mentioned ratio is less than (or respectively greater than) the above-mentioned predetermined value.

3. A method according to claim 2, consisting in displaying said result simultaneously with said color video image of the portion of the article as illuminated in ambient light or a video image of said portion of the article as illuminated in visible light.

4. A method according to claim 3, consisting in displaying the above-mentioned result in false colors superimposed on the video image of the article in ambient light or in visible light.

5. A method according to claim 1, consisting in taking images of the article by means of a red-green-blue type matrix video camera, and in using the red and blue components of said image to calculate the above-mentioned ratios.

6. A method according to claim 1, consisting in taking a plurality of video images of the portion of the article illuminated in ambient light and in ultraviolet light, in calculating the averages of said images, and then in using said averages for calculating the above-mentioned ratios.

7. Apparatus for performing the method described in claim 1, the apparatus comprising an ultraviolet light source for illuminating an article, video means for taking an image of the illuminated portion of the article, and data processor means receiving the output signals from the video means, wherein the video means comprise a color video camera, and wherein the data processor means are designed to subtract, point by point, an image of the portion of the article illuminated in ambient light from an image of the portion of the article illuminated in ultraviolet light so as to obtain a pure image, to extract the components from said pure image in the two wavelength bands respectively at high energy and at low energy, to take the ratios point by point of these two components, and to compare them with a predetermined value.

8. Apparatus according to claim 7, comprising means for displaying the results formed by the image points for which the ratios are less than (or respectively greater than) the predetermined value.

9. Apparatus according to claim 7, including means for displaying an ambient light image or a visible light image of said portion of the article and the result formed by the points of the image having ratios that are less than (or respectively greater than) the predetermined value.

10. Apparatus according to claim 7, wherein the color video camera is a CCD, CMOS, or photodiode matrix camera, or a color vidicon.

11. Apparatus according to claim 7, wherein the ultraviolet light source is an LED emitting in a wavelength band lying in the range about 300 nm to about 370 nm.

12. Apparatus according to claim 7, wherein both the ultraviolet light source and the color video camera including an image-forming lens are housed in a housing of small dimensions, and are connected by a flexible cable to the data processor means.

13. Apparatus according to claim 7, wherein the housing also contains a source of visible light for illuminating the article.
